(19) United States
(12) Patent Application Publication
(10) Pub. No.: US 2013/0061093 A1
(43) Pub. Date: Mar. 7, 2013

(54) DISTRIBUTED TEST SYSTEM AND METHOD, DISTRIBUTED TEST CONTROL SYSTEM AND METHOD, DISTRIBUTED TEST PLAN CREATING APPARATUS AND METHOD, DISTRIBUTED TEST AGENT, AND DISTRIBUTED TEST PLAN PERFORMING METHOD

(71) Applicant: Yeon Jun Choi, Daejeon (KR)

(72) Inventor: Yeon Jun Choi, Daejeon (KR)

(73) Assignee: Electronics and Telecommunications Research Institute, Daejeon (KR)

(21) Appl. No.: 13/541,331

(22) Filed: Jul. 3, 2012

(30) Foreign Application Priority Data
Sep. 6, 2011 (KR) 10-2011-0090378

(51) Int. Cl. G06F 11/28

(52) U.S. Cl. 714/27; 714/E11.178

(57) ABSTRACT

A distributed test plan creating apparatus and method, a distributed test control system and method, and a distributed test agent and method are provided which control a plurality of agents to generate a good number of virtual clients, monitor test results, and reflect feedback information. A master plan scenario is created to control a large-scale server test by using at least one or more distributed test agents, and based on the master plan scenario, a per-agent plan is created to control the operation to be fulfilled by each distributed test agent. The distributed test agent is controlled according to the per-agent plan. Test results are received and read to generate feedback information which is used to create a new master plan. Therefore, a large-scale distributed test may be performed to properly respond to changes in data and situations.

### CROSS-REFERENCE TO RELATED APPLICATION

This application claims priority to Korean Patent Application No. 10-2011-0090378 filed on Sep. 6, 2011, the contents of which are herein incorporated by reference in its entirety.

### TECHNICAL FIELD

Embodiments of the present invention concern a game test method, and more specifically to a method and apparatus of testing a load and function using a virtual client generated by a distributed test agent.

### DISCUSSION OF THE RELATED ART

In recent years, the market in online games has been sharply growing and conventional mainstream PC-based online games have been expanding to ones using dedicated consoles, PDAs, or smartphones. As a consequence, more and more users attempt to access a single game server online, which causes the server to be often frozen or makes efficient access management more difficult.

In particular, mainly targeted for generation of huge profits rather than other game genres for mere advertisement, massively multiplayer online role playing games (shortly “MMORPG”) are required to provide more stable services to users. Users place more and more demands on online games, and in response, the games are gradually equipped with various and sophisticated functions. In this sense, it is crucial for the functions to work smoothly on the games.

Accordingly, a newly-developed online game, as a measure to guarantee stability of the server, is subjected to a beta test before released in the market. Two different types of beta tests are present which include closed and open beta tests. A beta service is in progress in such a way that a pilot service is provided to some testers, such as small personnel or Internet users chosen, who then generate feedback on functional errors or problems while load test or other server stability verification are conducted.

However, such beta tests are performed by humans, thus resulting in many disadvantages. For example, beta testers should be gathered and much time and cost would be consumed for the test. Further, human testers cannot clearly provide any problems with the game, which causes it difficult for developers to understand situations. Also, any problems may occur in real time while the game is ongoing, so that it is difficult to exactly reproduce the problematic situations.

Much effort to create more complete games and to effectively test the games has been dedicated to technologies in which the game test can be fulfilled by computers but not humans. Demand for game test technologies that may provide such effects as if a human attends the game test but does not in reality has been increasing. To respond to such necessity, there have been suggested methods of testing load applied to a server and of generating virtual clients for a particular game and applying them to the game.

Also, apparatuses and methods have been suggested that may create modules for generating and controlling virtual clients specialized for each game by receiving only unique information of the game and may perform a test on the game by using the modules. Furthermore, game test apparatuses and methods of being able to test load applied to the server by data packets generated as the game is played and to test whether functions unique for the game and necessary to play the game are smoothly fulfilled.

However, those methods may support only distributed client programs in a single physical system together with merely replaying predetermined data or scenarios, but may not properly respond to changes in data and situations. Moreover, such methods fail to support interactions between distributed client systems.

### SUMMARY

Embodiments of the present invention provide a distributed test plan creating apparatus and method, a distributed test control system and method, and a distributed test agent and method, which may control a plurality of agents logically or physical separated from each other when testing an online game played by a good number of users, so that the test may be fulfilled without any user as if the user is involved in the test and which may monitor test results to generate feedback information and may reflect the feedback information upon creating a master plan scenario so as to properly respond to changes in data and situations.

According to an embodiment of the present invention, there is provided a distributed test control system including a distributed test plan creating apparatus configured to create a master plan scenario for controlling a server test by using at least one distributed test agent and to create a per-agent plan for controlling an operation to be fulfilled by the distributed test agent based on the master plan scenario and a distributed test agent control apparatus configured to transmit and receive information to/from the distributed test plan creating apparatus and the distributed test agent and to control the distributed test agent according to the per-agent plan.

The master plan scenario includes at least one of the number of total virtual clients, the number of virtual clients to be generated by the distributed test agent, or a task responsible by the distributed test agent, and wherein the per-agent plan includes at least one of game actions of each virtual clients, the game actions including message transmission, equipment exchange, move, displine, or attack.

The distributed test plan creating apparatus and the distributed test agent control apparatus are configured to transmit and receive information through a network or by moving a storage medium.

The at least distributed test agent includes first and second distributed test agents which are physically or logically separated from each other.

The distributed test plan creating apparatus further includes a test monitoring unit, wherein the distributed test agent control apparatus is configured to a result of the test from each distributed test agent and to transfers the result of the test to the test monitoring unit of the distributed test plan creating apparatus, wherein the test monitoring unit is configured to read the result of the test to generate feedback information, and the distributed test plan creating apparatus is configured to create a new master plan scenario based on the feedback information.

According to an embodiment of the present invention, there is provided a distributed test plan creating apparatus including a master plan scenario creating unit configured to create a master plan scenario for controlling a server test by using at least one distributed test agent and a per-agent plan creating unit configured to create a per-agent plan for controlling an operation to be fulfilled by the distributed test agent based on the master plan scenario.

According to an embodiment of the present invention, there is provided a distributed test agent including a communication unit configured to transmit and receive information to/from a test control system and a virtual client generating unit configured to generate at least one virtual client, wherein the virtual client is generated by a per-agent plan received through the communication unit, to apply load to a game server according to a preset operation to perform a test, and to receive a result of the test.

According to an embodiment, a plurality of distributed test agents are provided which are physically or logically separated from each other.

According to the embodiments of the present invention, the distributed test plan creating apparatus and method, the distributed test control system and method, and the distributed test agent and method may control a plurality of agents logically or physical separated from each other to generate a number of virtual clients, so that a test may be, without a user's actual test, performed as if the user is actually involved in the test. The embodiments of the present invention differ from the related art that generates virtual clients through a single agent. Further, test results may be monitored and fed back, thus enabling the test plan to be dynamically updated and reflected with test situations and degree of load. Accordingly, effects closer to actual tests may be achieved.

Therefore, time and costs required for a beta test before the game is released in the market to judge server stability, functions, and degree of load may be saved.

### BRIEF DESCRIPTION OF THE DRAWINGS

The embodiments of the present invention will become readily apparent by reference to the following detailed description when considered in conjunction with the accompanying drawings wherein:

FIG. 1 is a view illustration a concept of a distributed test system according to an embodiment of the present invention;

FIG. 2 is a block diagram specifically illustrating the distributed test control system 100 shown in FIG. 1;

FIG. 3A is a block diagram specifically illustrating the distributed test plan creating apparatus 110 shown in FIG. 2;

FIG. 3B is a block diagram schematically illustrating the distributed test control system 100 shown in FIG. 2 when a feedback process is reflected;

FIG. 4 is a block diagram schematically illustrating the distributed test agent 200 shown in FIG. 1;

FIG. 5 is a flowchart illustrating a distributed test method according to an embodiment of the present invention;

FIG. 6 is a flowchart specifically illustrating the distributed test control method shown in FIG. 5; and

FIG. 7 is a flowchart specifically illustrating the distributed test plan performing step S520 shown in FIG. 5.

### DESCRIPTION OF THE EMBODIMENTS

Hereinafter, the embodiments of the present invention will be described with reference to the accompanying drawings, wherein the same reference numerals may be used to denote the same or substantially the same elements throughout the specification and the drawings.

Various modifications and variations may be made to the present invention. Hereinafter, some particular embodiments will be described in detail with reference to the accompanying drawings.

However, it should be understood that the present invention is not limited to the embodiments and all the variations or replacements of the invention or their equivalents are included in the technical spirit and scope of the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings, wherein the same reference numerals may be used to denote the same or substantially the same elements throughout the specification and the drawings, and description on the same elements will be not repeated.

<Apparatus>

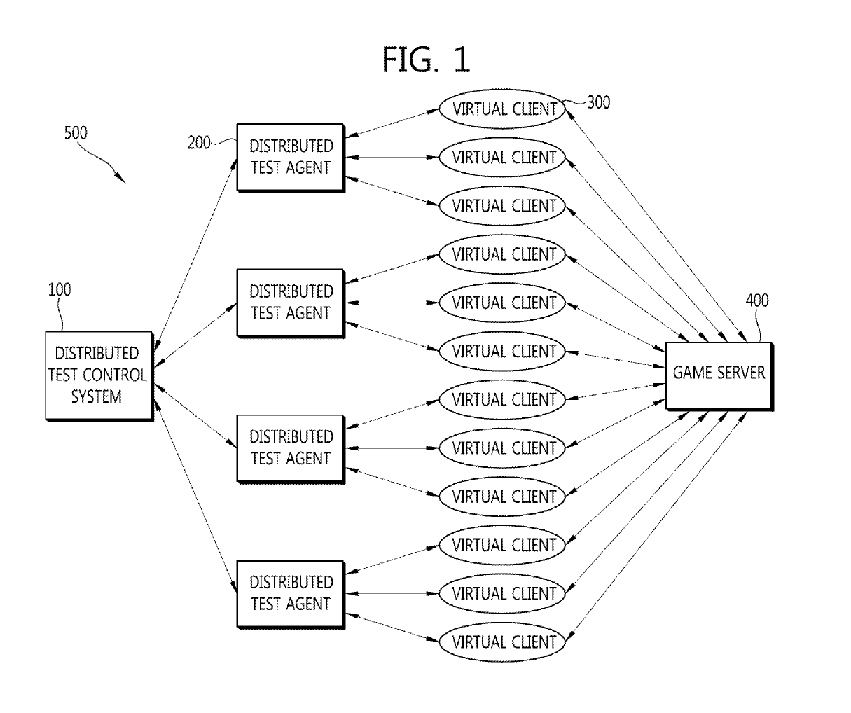

FIG. 1 is a view illustration a concept of a distributed test system according to an embodiment of the present invention.

Referring to FIG. 1, the distributed test system 500 may include a distributed test control system 100, distributed test agents 200, virtual clients 300, and a game server 400.

The distributed test control system 100 generates a master plan scenario to perform a large scale distributed test and based on the master plan scenario creates a plan for each agent (shortly “per-agent plan”) to control the operation of each distributed test agent 200. The created plans are transmitted to the distributed test agents 200 via a network or by moving a storage medium. According to an embodiment, one or more distributed test agents 200 may be provided that may be physically or logically distributed. Each distributed test agent 200 generates a plurality of virtual clients 300 according to the per-agent plan. The virtual clients 300 operate as indicated on the per-agent plan under the control of their corresponding distributed test agent 200 to test the game server 400. Test information generated during the test are transferred via the distributed test agent 200 to the distributed test control system 100 which then feeds back the test information to create a new master plan by which the large-scale distributed test may be repeated.

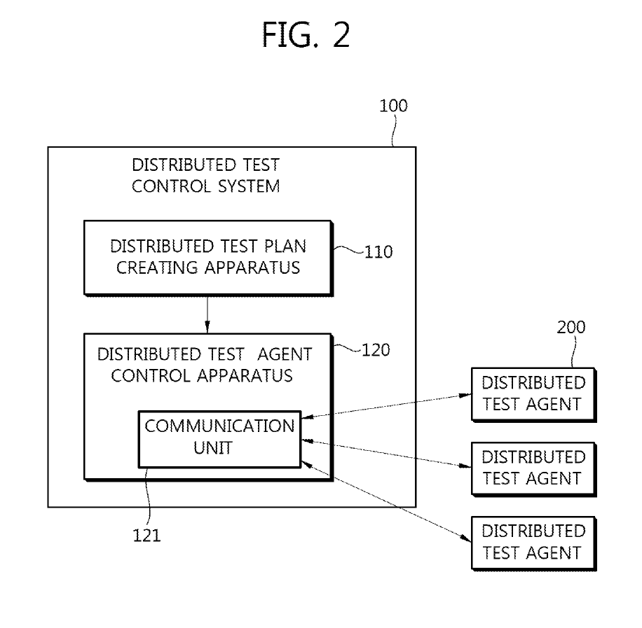

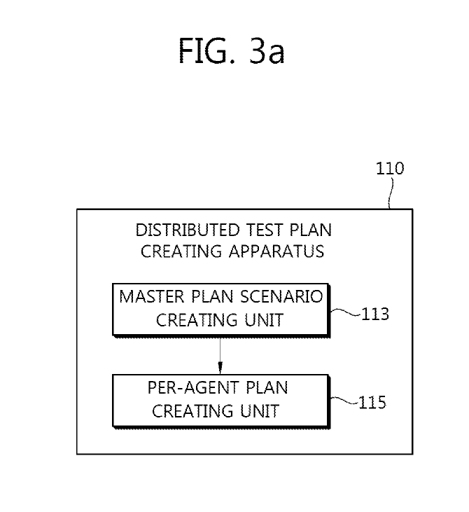

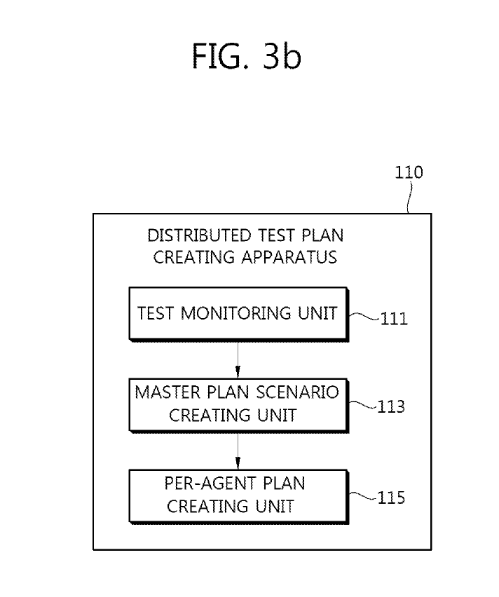

FIG. 2 is a block diagram specifically illustrating the distributed test control system 100 shown in FIG. 1, and FIG. 3A is a block diagram specifically illustrating the distributed test plan creating apparatus 110 shown in FIG. 2.

Referring to FIGS. 2 and 3A, the distributed test control system 100 includes a distributed test plan creating apparatus 110 and a distributed test agent control apparatus 120. The distributed test plan creating apparatus 110 includes a master plan scenario creating unit 113 and a per-agent plan creating unit 115.

Specifically, the master plan scenario creating unit 113 creates a master plan scenario that controls a large-scale server test by using at least one or more distributed test agents, and the per-agent plan creating unit 115 creates per-agent plans that control the operation of each distributed test agent based on the master plan scenario. The distributed test agent control apparatus 120 includes a communication unit 121 that transmits and receives information to/from the distributed test plan creating apparatus 110 and the distributed test agents 200. The distributed test agent control apparatus 120 controls the distributed test agents 200 according the per-agent plans.

The master plan scenario may reflect purposes of the distributed test that may include a server load test or function test. The master plan scenario may include contents for properly adjusting load of each distributed test agent 200. The master plan scenario may determine the total number of the virtual clients 300 for the distributed test and may distribute the virtual clients 300 to be generated by the distributed test agent 200. For such distribution of the virtual clients 300, a weight value may be considered depending on the test information from the distributed test agent 200 and the type of a task fulfilled by the distributed test agent 200. Further, a task to be mainly responsible by each distributed test agent 200 is to be designated, so that the virtual client 300 generated by its corresponding agent 200 may conduct the designated task.

The per-agent plan controls the operation to be performed by its corresponding distributed test agent 200, more specifically the virtual client 300, based on the master plan scenario. Based on the task mainly responsible by each distributed test agent 200 or the number of the virtual clients 300 to be generated by each distributed test agent 200 by the master plan scenario, the operation of each virtual client 300 is designated. The operation may include at least one of game actions, such as message transmission, equipment exchange, move, displine, or attacks, or game grammar-based captured packets.

The per-agent plan created by the per-agent plan creating unit 115 is transmitted to the communication unit 210 of the distributed test agent 200 via the communication unit 121 of the distributed test agent control apparatus 120. The communication unit 121 of the distributed test agent control apparatus 120 and the communication unit 210 of the distributed test agent 200 may transmit and receive information through a network or by moving a storage medium. For this purpose, the communication unit 121 may include a network communication network, a apparatus for recording data in a storage medium, or a apparatus for reading data from a storage medium.

According to an embodiment, a plurality of distributed test agents 200 may be present which are logically or physically distributed. Conventionally, a single physical system supports a distributed client program alone. According to an embodiment, a distributed test agent 200 may be provided in each of a plurality of physically separated systems, or alternatively, a plurality of logically separated distributed test agents 200 may be provided in a single physical system. Thus, a large-scale virtual client group may be generated.

FIG. 3B is a block diagram schematically illustrating the distributed test control system 100 shown in FIG. 2 when a feedback process is reflected.

The distributed test plan creating apparatus 110 may further include a test monitoring unit 111. The communication unit 121 of the distributed test agent control apparatus 120 may receive a test result from the communication unit 210 of the distributed test agent 200 and transfer the test result to the test monitoring unit 111 of the distributed test plan creating apparatus 110. The test monitoring unit 111 reads the test result to generate feedback information and transmits the feedback information to the per-agent plan creating unit 115. The per-agent plan creating unit 115 may create a new master plan scenario based on the feedback information. Based on the created master plan scenario, the per-agent plan is created which controls the operation to be conducted by each distributed test agent, so that the distributed test may be repeatedly carried out.

The test information may include at least one of a response time for the virtual client's operation, whether a function works or not, and whether an error occurs or not. Based on the test information, the feedback information may be generated which may include whether each distributed test agent 200 normally operates or not and the degree of distribution. For the distribution of the total number of the virtual clients 300 for the distributed test and the number of the virtual clients 300 to be generated by each distributed test agent 200, the feedback information is reflected so that the distributed test may be dynamically performed in consideration of the test situations and load.

According to an embodiment, the distributed test control system 100 includes the distributed test plan creating apparatus 110 as one component. Alternatively, the distributed test plan creating apparatus 110 may be provided independently from the distributed test control system 100. As shown in FIG. 3A, the distributed test plan creating apparatus may include a master plan scenario creating unit that creates a master plan scenario for controlling a large-scale server test by using at least one or more distributed test agents and a per-agent plan creating unit that creates a per-agent plan for controlling the operation to be fulfilled by each distributed test agent based on the master plan scenario.

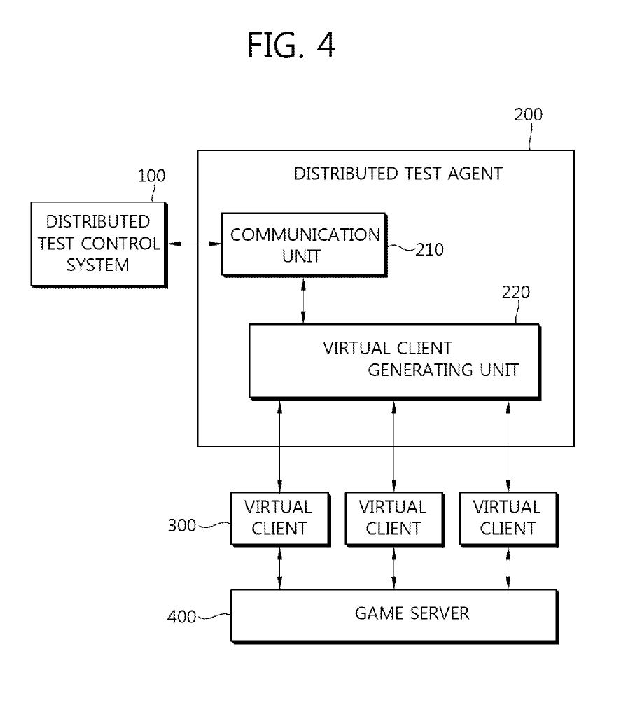

FIG. 4 is a block diagram schematically illustrating the distributed test agent 200 shown in FIG. 1.

The distributed test agent 200 includes a communication unit 210 that transmits and receives information to/from the distributed test control system 100 and a virtual client generating unit 220 that generates at least one or more virtual clients 300 to perform a test based on the per-agent plan received through the communication unit 210. Each virtual client 300 applies load to the game server 400 according to a preset operation generated by the per-agent plan so as to perform a test and receives a result of the test.

The communication unit 121 of the distributed test agent control apparatus 120 in the distributed test control system 100 transmits the generated per-agent plan to the communication unit 210 of the distributed test agent 200. The per-agent plan is transferred to the virtual client generating unit 220 which in turn generates a group of virtual clients 300 to perform a task designated depending on the number designated by the per-agent plan. The group of virtual clients 300 applies load to the game server 400 through a preset operation to perform a test and receives a result of the test. The test result is transferred back to the communication unit 121 of the distributed test agent control apparatus 120 via the communication unit 210 of the distributed test agent 200.

According to an embodiment, a plurality of distributed test agents 200 which are physically or logically distributed may be provided. Conventionally, a single physical system supports a distributed client program alone. According to an embodiment, a distributed test agent 200 may be provided in each of a plurality of physically separated systems, or alternatively, a plurality of logically separated distributed test agents 200 may be provided in a single physical system. Thus, a large-scale virtual client group may be generated.

<Method>

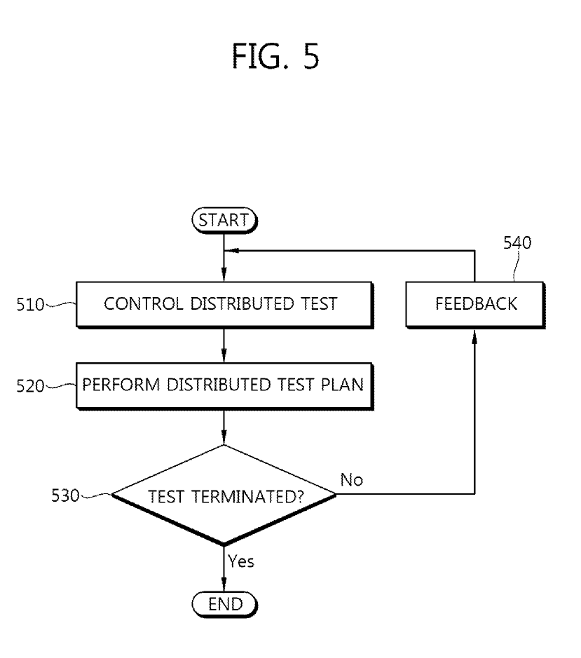

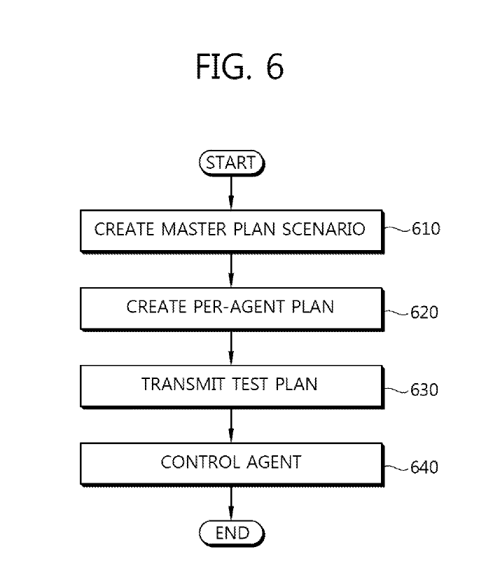

FIG. 5 is a flowchart illustrating a distributed test method according to an embodiment of the present invention. FIG. 6 is a flowchart specifically illustrating the distributed test control method shown in FIG. 5.

Referring to FIG. 6, the distributed test control method 100 includes a step of creating a master plan scenario for controlling a large-scale server test by using at least one or more distributed test agents (S610), a step of creating a per-agent plan for controlling the operation to be fulfilled by each distributed test agent based on the master plan scenario (S620), a step of transmitting the created per-agent plan to a distributed test agent control apparatus (S630), and a step of controlling the distributed test agent according to the per-agent plan (S640).

Referring to FIGS. 1 and 6, in the distributed test control method according to an embodiment, the master plan scenario may reflect purposes of the distributed test that may include a server load test or function test. The master plan scenario may include contents for properly adjusting load of each distributed test agent 200. The master plan scenario may determine the total number of the virtual clients 300 for the distributed test and may distribute the virtual clients 300 to be generated by the distributed test agent 200. For such distribution of the virtual clients 300, a weight value may be considered depending on the test information from the distributed test agent 200 and the type of a task fulfilled by the distributed test agent 200. Further, a task to be mainly responsible by each distributed test agent 200 is to be designated, so that the virtual client 300 generated by its corresponding agent 200 may conduct the designated task.

The per-agent plan controls the operation to be performed by its corresponding distributed test agent 200, more specifically the virtual client 300, based on the master plan scenario. Based on the task mainly responsible by each distributed test agent 200 or the number of the virtual clients 300 to be generated by each distributed test agent 200 by the master plan scenario, the operation of each virtual client 300 is designated. The operation may include at least one of game actions, such as message transmission, equipment exchange, move, displine, or attacks, or game grammar-based captured packets.

In the test plan transmission step S630, the created per-agent plan is transmitted to the distributed test agent control apparatus. Transmission and reception of information may be performed through a network or by moving a storage medium.

According to an embodiment, a plurality of distributed test agents 200 may be present which are logically or physically distributed. Conventionally, a single physical system supports a distributed client program alone. According to an embodiment, a distributed test agent 200 may be provided in each of a plurality of physically separated systems, or alternatively, a plurality of logically separated distributed test agents 200 may be provided in a single physical system. Thus, a large-scale virtual client group may be generated.

Referring to FIGS. 1, 5, and 6, a distributed test control method reflected with a feedback process is now described. According to an embodiment, the distributed test control method may perform the feedback process after receiving test information.

According to an embodiment, the distributed test control method may further include a feedback step S540 of receiving test information from a distributed test agent, reading the test information, and generating feedback information. The step S610 may include creating a new master plan scenario based on the feedback information. Based on the created master plan scenario, the per-agent plan is created which controls the operation to be conducted by each distributed test agent, so that the distributed test may be repeatedly carried out.

The test information may include at least one of a response time for the virtual client's operation, whether a function works or not, and whether an error occurs or not. Based on the test information, the feedback information may be generated which may include whether each distributed test agent 200 normally operates or not and the degree of distribution. For the distribution of the total number of the virtual clients 300 for the distributed test and the number of the virtual clients 300 to be generated by each distributed test agent 200, the feedback information is reflected so that the distributed test may be dynamically performed in consideration of the test situations and load.

According to an embodiment, the distributed test control method includes the distributed test plan creating method as one component. Alternatively, the distributed test plan creating method may be provided independently from the distributed test control method. The distributed test plan creating method may include the step S610 that creates a master plan scenario for controlling a large-scale server test by using at least one or more distributed test agents and the step S620 that creates a per-agent plan for controlling the operation to be fulfilled by each distributed test agent based on the master plan scenario.

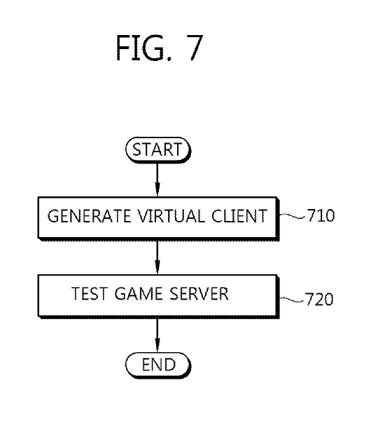

FIG. 7 is a flowchart specifically illustrating the distributed test plan performing step S520 shown in FIG. 5.

According to an embodiment, the distributed test plan performing step includes a step S710 of generating at least one or more virtual clients 300 to perform a test according to a per-agent plan generated by the distributed test plan creating method S510 and a step S720 of allowing the virtual client to apply load to the game server 400 according to a preset operation so as to perform a test and of receiving a result of the test. According to an embodiment, a further step S540 may be provided which reads the test result and generates feedback information.

According to an embodiment, a plurality of distributed test agents 200 may be present which are logically or physically distributed. Conventionally, a single physical system supports a distributed client program alone. According to an embodiment, a distributed test agent 200 may be provided in each of a plurality of physically separated systems, or alternatively, a plurality of logically separated distributed test agents 200 may be provided in a single physical system. Thus, a large-scale virtual client group may be generated.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A distributed test control system comprising:
a distributed test plan creating apparatus configured to create a master plan scenario for controlling a server test by using at least one distributed test agent and to create a per-agent plan for controlling an operation to be fulfilled by the distributed test agent based on the master plan scenario; and
a distributed test agent control apparatus configured to transmit and receive information to/from the distributed test plan creating apparatus and the distributed test agent and to control the distributed test agent according to the per-agent plan.

2. The distributed test control system of claim 1, wherein the master plan scenario includes at least one of the number of total virtual clients, the number of virtual clients to be generated by the distributed test agent, or a task responsible by the distributed test agent, and wherein the per-agent plan includes at least one of game actions of each virtual clients, the game actions including message transmission, equipment exchange, move, displine, or attack.

3. The distributed test control system of claim 1, wherein the distributed test plan creating apparatus and the distributed test agent control apparatus are configured to transmit and receive information through a network or by moving a storage medium.

4. The distributed test control system of claim 1, wherein the at least distributed test agent includes first and second distributed test agents which are physically or logically separated from each other.

5. The distributed test control system of claim 1, wherein the distributed test plan creating apparatus further includes a test monitoring unit, wherein the distributed test agent control apparatus is configured to a result of the test from each distributed test agent and to transfers the result of the test to the test monitoring unit of the distributed test plan creating apparatus, wherein the test monitoring unit is configured to read the result of the test to generate feedback information, and the distributed test plan creating apparatus is configured to create a new master plan scenario based on the feedback information.

6. A distributed test agent comprising:
a communication unit configured to transmit and receive information to/from a test control system; and
a virtual client generating unit configured to generate at least one virtual client, wherein the virtual client is generated by a per-agent plan received through the communication unit, to apply load to a game server according to a preset operation to perform a test, and to receive a result of the test.

7. The distributed test agent of claim 6, which is physically or logically separated from another distributed test agent.

8. A distributed test control method comprising:
creating a master plan scenario for controlling a server test by using at least one distributed test agent;
creating a per-agent plan for controlling an operation to be fulfilled by the distributed test agent based on the master plan scenario; and
controlling the distributed test agent according to the per-agent plan.

9. The distributed test control method of claim 8, wherein the master plan scenario includes at least one of the number of total virtual clients, the number of virtual clients to be generated by the distributed test agent, or a task responsible by the distributed test agent, and wherein the per-agent plan includes at least one of game actions of each virtual clients, the game actions including message transmission, equipment exchange, move, displine, or attack.

10. The distributed test control method of claim 8, wherein the created per-agent plan is transmitted to a distributed test agent control apparatus through a network or by moving a storage medium.

11. The distributed test control method of claim 8, wherein the at least distributed test agent includes first and second distributed test agents which are physically or logically separated from each other.

12. The distributed test control method of claim 8, further comprising receiving a result of the rest from the distributed test agent, reading the result of the rest, and generating feedback information, wherein creating the distributed test plan includes creating a new master plan scenario based on the feedback information.
